(19) United States
(12) Patent Application Publication
(10) Pub. No.: US 2004/0008380 A1
(43) Pub. Date: Jan. 15, 2004

(54) Image forming apparatus with image combining capability

(76) Inventor: Tadahide Sawamura, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/455,353

(22) Filed: Jun. 6, 2003

(30) Foreign Application Priority Data
Jun. 7, 2002 (JP) 2002-166646 (JP)

(51) Int. Cl. H04N 1/387; H04N 1/04; G06K 15/02

(52) U.S. Cl. 358/1.18; 358/450; 358/474; 399/374

(57) ABSTRACT

An image forming apparatus capable of combining image data representative of images carried on both sides of a duplex document of the present invention includes a reading device for reading the images on both sides of the document. Data derived from the images of both sides of the document are written to a storage and then combined to produce combined image data. An image forming device forms a composite image in accordance with the combined image data.

### BACKGROUND OF THE INVENTION

1. Field of the Invention

The present invention relates to a copier or similar image forming apparatus capable of combining two document images read and more particularly to an image forming apparatus configured to combine image data representative of opposite sides of a duplex document.

2. Description of the Background Art

Today, a digital copier or similar digital image forming apparatus, replacing an analog image forming apparatus, is provided with a stamp printing function, an image combining function and other various functions particular to a digital system. Further, a copier, for example, with a duplex copying function, i.e., capable of copying images on both sides of a sheet is extensively used for protecting environment and saving energy. In such circumstances, a current trend in the copier art is toward the use of duplex documents implemented by the above function. In parallel with such a trend, a copier with document reading means capable of reading opposite sides of a duplex document has been developed.

The precondition with the conventional copier having the image combining function is that two or more images to be combined be derived from simplex or one-sided documents. This precondition is acceptable so long as a majority of documents are simplex documents, but is not desirable when it comes to the increasing use of duplex copies as documents.

More specifically, when the conventional copier with the image combining function is operated to combine two images carried on opposite sides of a duplex document, it is necessary to produce two simplex copies with opposite sides of the document and then combine the images of the two simplex copies. Such a procedure, however, needs extra processing for transforming the duplex document to two simplex documents and forces the operator to perform troublesome work for combining the resulting two images. Further, the duplex document to be dealt with by the copier is usually spread in either one of the right-and-left direction and up-and-down direction, so that a desired combined image is not attainable unless the operator adequately selects the right-and-left or the up-and-down spread position while confirming whether or not the selection is adequate, resulting in additional load on the operator.

### SUMMARY OF THE INVENTION

It is an object of the present invention to provide an image forming apparatus capable of executing adequate image combining operation with a duplex document while obviating extra load on the operator of the apparatus.

An image forming apparatus capable of combining image data representative of images carried on both sides of a duplex document of the present invention includes a reading device for reading the images on both sides of the document. Data derived from the images of both sides of the document are written to a storage and then combined to produce combined image data. An image forming device forms a composite image in accordance with the combined image data.

### BRIEF DESCRIPTION OF THE DRAWINGS

The above and other objects, features and advantages of the present invention will become more apparent from the following detailed description taken with the accompanying drawings in which:

FIG. 1 is a view showing the general construction of an image forming apparatus embodying the present invention;

FIG. 2 is a plan view showing a specific arrangement of a control panel included in the illustrative embodiment;

FIG. 3 shows a specific picture to appear on an LCD (Liquid Crystal Display) touch panel included in the control panel for allowing the operator of the apparatus to input desired modes;

FIG. 4 shows another specific picture to appear on the LCD touch panel when the operator selects a duplex document composite mode on the picture of FIG. 3;

FIG. 5 is a schematic block diagram showing a control system included in the illustrative embodiment;

FIG. 6 is a schematic block diagram showing circuitry included in an image processing unit shown in FIG. 5;

FIG. 7 is a schematic block diagram showing the image processing unit of FIG. 6 more specifically;

FIG. 8 is a schematic block diagram showing circuitry included in an image memory controller shown in FIG. 7 while demonstrating image inputting operation thereof;

FIG. 9 is a schematic block diagram similar to FIG. 8, demonstrating image outputting operation;

FIG. 10 shows a specific duplex document and a combined image derived therefrom; and

FIG. 11 shows another specific picture that may appear on the LCD touch panel when the duplex document composite mode is selected.

### DESCRIPTION OF THE PREFERRED EMBODIMENT

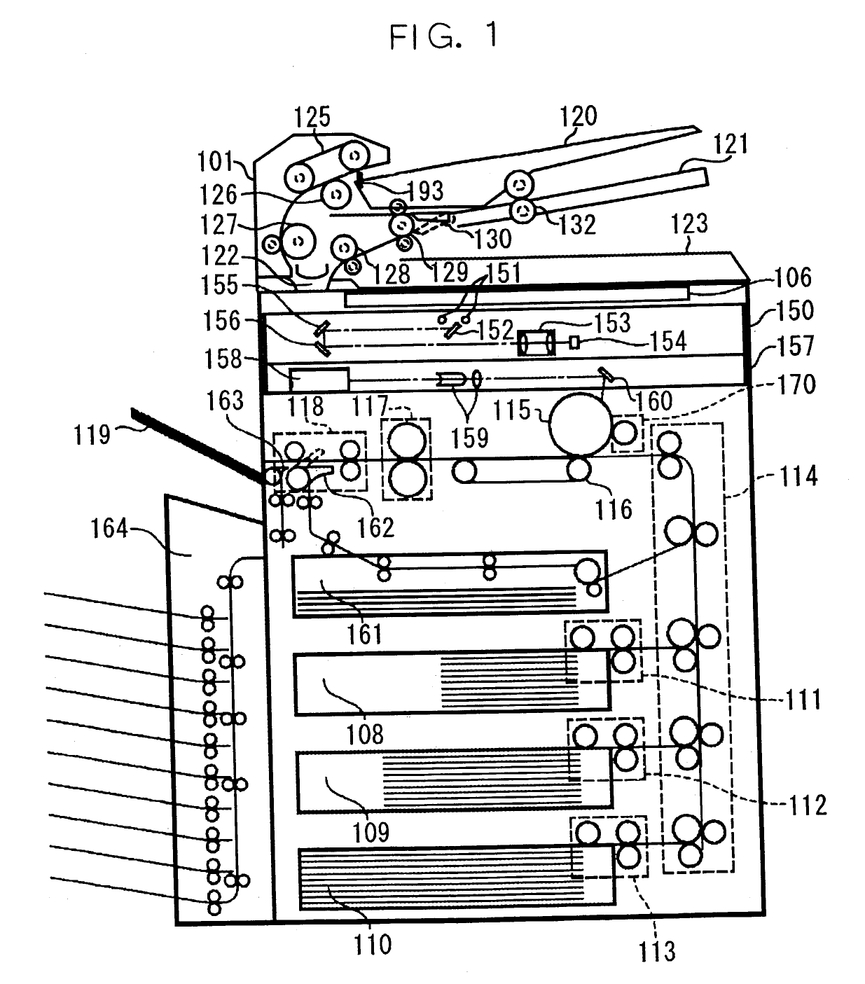

Referring to FIG. 1 of the drawings, an image forming apparatus embodying the present invention is shown and implemented as a copier by way of example. The construction and basic operation, including document reading and image writing, of the copier will be described hereinafter.

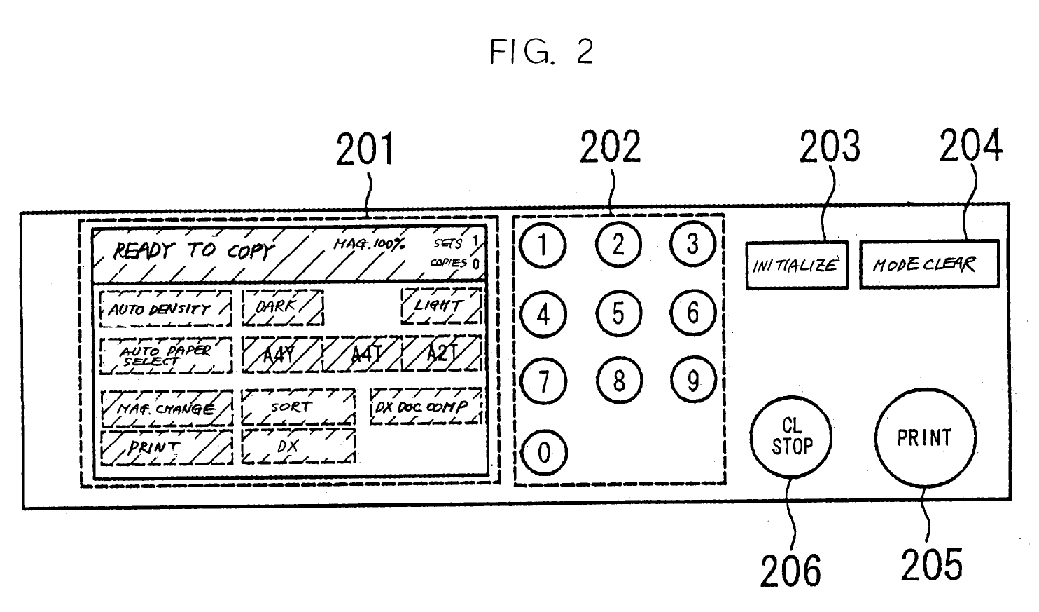

First, as for document reading, the copier is selectively operable in a simplex or a duplex document mode. In the simplex document mode, the operator of the copier stacks documents on a tray 120 included in an ADF (Automatic Document Feeder) 101 and then presses a print key 205 positioned on a control panel (see FIG. 2). In response, a pickup belt 125 and a reverse roller 126 cooperate to pay out the bottom document of the stack. The document thus paid out is conveyed by a pullout roller 127, an auxiliary roller 128 and an outlet roller 129 while being read by a scanning unit 150 at a read position. The document is then driven out to a tray 123 by the outlet roller 129. At this instant, a path selector 130 is held in an inoperative position.

In the duplex document mode, after one side of the bottom document has been read in the same manner as in the simplex document mode, the path selector 130, switched to an operative position then, steers the document toward a turn tray 121 via a turn roller 132, thereby turning back the document. Subsequently, the path selector 130 is again switched to the inoperative position, so that the document guided toward the pullout roller 127. As a result, the document is conveyed by the pullout roller 127, auxiliary roller 128 and outlet roller 129 while having its other side read at the read position 122 and is then driven out to the tray 123.

After the above document has been read, when set document sensing means 193 senses the next document present on the tray 120, the next document is conveyed and read in the same manner as the first document. A motor, not shown, drives the conveying mechanism included in the ADF 101.

In an optical writing unit 157, a laser unit 158 cans a photoconductive drum or image carrier 115 with a laser beam in accordance with image data output from the scanning unit 150, thereby forming a latent image on the drum 115. A developing unit 170 develops the latent image with toner to thereby produce a corresponding toner image.

A first, a second and a third tray 108, 109 and 110, respectively, each are loaded with a stack of sheets and provided with a first, a second and a third sheet feeding device 111, 112 and 113, respectively. One of the sheet feeding devices 111 through 113 pays out one sheet from associated one of the trays 108 through 110 toward a vertical conveying unit 114. The vertical conveying unit 114 conveys the sheet to the drum 115. Subsequently, a belt 116 conveys the sheet at the same speed as the rotation of the drum 115 with the result that the toner image is transferred from the drum 115 to the sheet. Subsequently, a fixing unit 117 fixes the toner image on the sheet. Finally, the sheet or copy is driven out to a copy tray 119 by a sheet discharging unit 118.

In a duplex copy mode, a path selector 162 is switched upward to steer the sheet, carrying the toner image on one side thereof, toward a duplex copy unit 161 instead of toward the copy tray 119. The sheet is once stacked on the duplex copy unit 161 and again fed to the drum 115, so that another toner image is transferred from the drum 115 to the other side of the sheet, completing a duplex copy. Subsequently, the path selector 162 is switched downward and, if a finisher mode using a finisher 164 is selected, a path selector 163 is switched upward, steering the duplex copy to the finisher 164. In a mode not using the finisher 164, the path selector 163 is switched downward to steer the duplex copy to the copy tray 119.

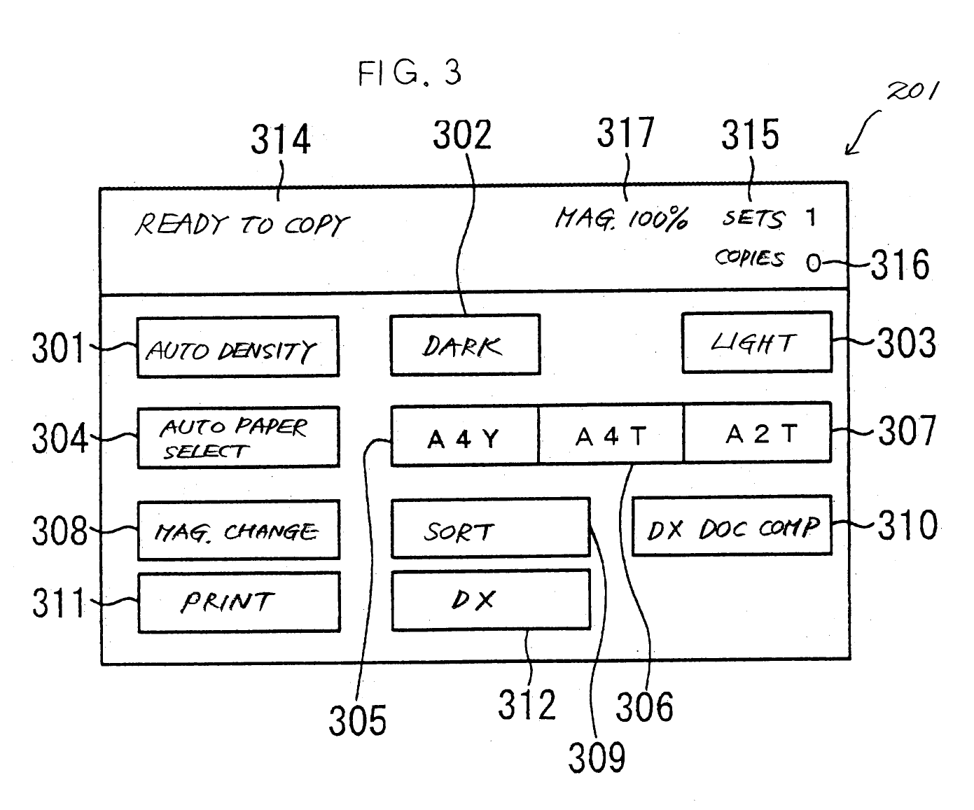

FIG. 2 shows a specific configuration of the control panel while FIG. 3 shows a specific picture appearing on an LCD touch panel 201 included in the control panel. As shown in FIG. 2, the control panel includes, in addition to the print key 205 and LCD touch panel 201, ten keys 202, an initialize key 203, a mode clear key 204, and a clear/stop key 206. The touch panel 201 serves as both of a display and keys. More specifically, as shown in FIG. 3, the touch panel 201 displays mode keys 301 through 312, a set number 315, a number of copies 316, a magnification 317, and a message 314 representative of the status of the apparatus as well as mode keys for allowing the operator to set or cancel various image forming modes. Particularly, in the illustrative embodiment, the mode keys include a duplex document composite key 310 operable to select a composite copy mode using a duplex document.

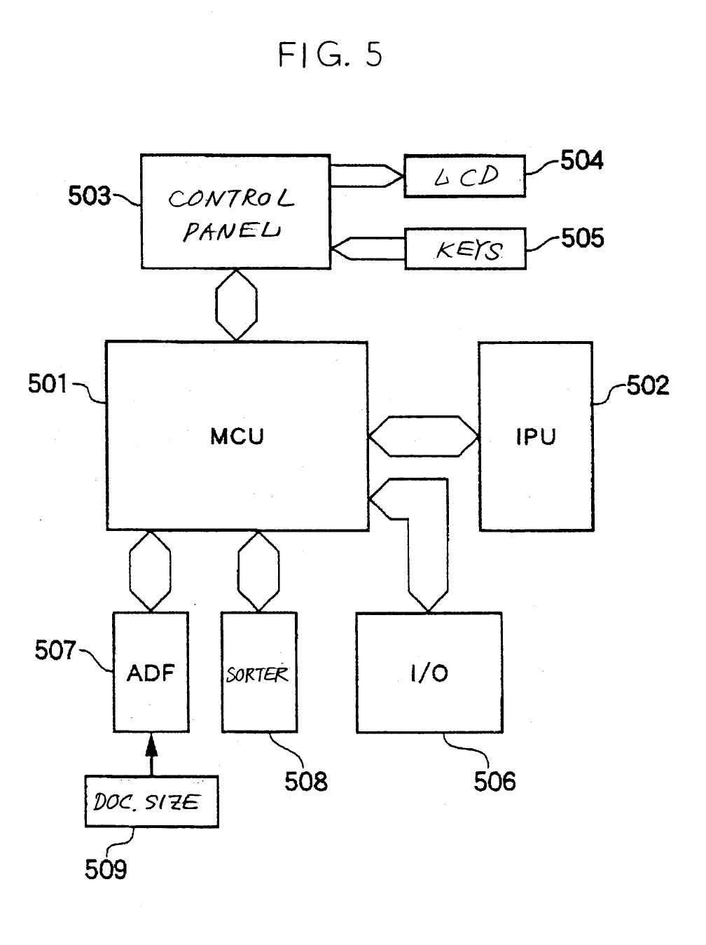

FIG. 5 shows a control system included in the illustrative embodiment and including a main controller (MCU) 501. As shown, scattered control units, including a control panel 503, an image processing unit (IPU) 502, an ADF 507 and a sorter or finishing controller 508, are connected to the MCU 501, which controls the entire copier. The control panel 503 displays information meant for the operator and executes input control in accordance with functions or modes selected by the user. The IPU 502 controls a scanner, writing of image data in an image memory, and image formation using the image data read out of the image memory. Each scattered control unit and MCU 501 interchange the status of the machine and commands, as needed. A main motor and clutches for, e.g., sheet conveyance are connected to an I/O (Input/Output) board 506 although not shown specifically, and controlled by the MCU 501.

Referring again to FIG. 1, how the illustrative embodiment forms a latent image representative of a document image on the drum 115 will be described in detail. It is to be noted that a latent image is represented by a potential distribution formed on the drum 115.

In the illustrative embodiment, the scanning unit 150 can read not only a document being conveyed by the ADF 101, as stated earlier, but also a book spread on a glass platen 106. To read a book, the illustrative embodiment additionally includes the glass platen 106 and an optical scanning system including a lamp 151, a first mirror 152, a lens 153, and a CCD (Charge Coupled Device) image sensor 154. The lamp 151 and first mirror 152 are mounted on a first carriage, not shown, while the second mirror 155 and third mirror 156 are mounted on a second carriage not shown. To read a document, the first carriage is caused to run along a document surface at a speed two times as high as the speed of the second carriage, so that the length of the optical path does not change. Such mechanical subscanning is effected by a scanner motor not shown.

To read a document being conveyed by the ADF, the first and second carriages stated above are held stationary at a position corresponding to the ADF read position 122 mentioned earlier.

In any case, a document image transferred via the optical scanning system is read by the CCD image sensor 154 and converted to an electric image signal thereby.

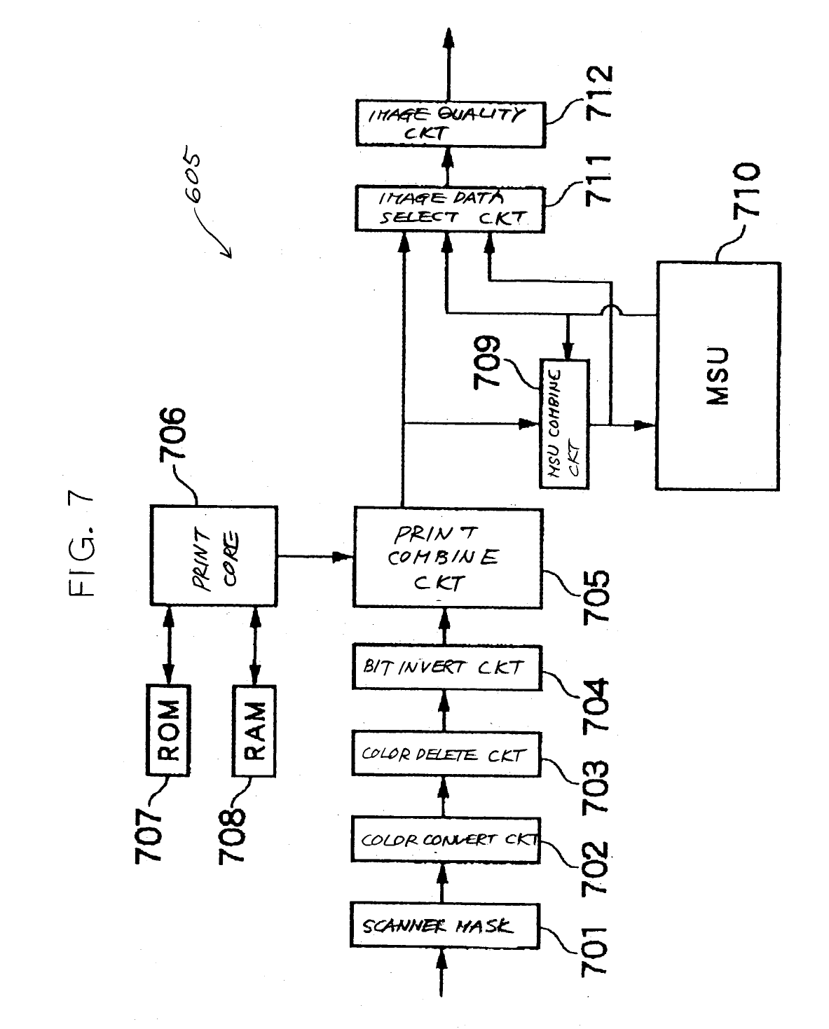

The optical writing unit 157 includes the laser unit 158, a lens 159, and a mirror 160. The laser unit 158 includes a laser diode or light source and a polygonal mirror rotated by a motor at a constant speed. A laser beam, issuing from the laser diode is steered by the polygonal mirror, transmitted through the lens 159, turned by the mirror 160, and then incident to the drum 115. The laser beam scans the drum 115 in a direction perpendicular to a direction in which the drum 115 rotates, i.e., in the main scanning direction. As a result, image data are recorded on the drum 115 line by line in accordance with an image signal output from a selector 711 (see FIG. 7), which is included in the IPU 502. Main scanning is repeated at a preselected period corresponding to the rotation speed of the drum 115 and recording density, forming a latent image on the drum 115.

A beam sensor, not shown, is positioned in the vicinity of one end of the drum 115. Every time the laser beam, scanning the drum 115, is incident to the beam sensor, the beam sensor outputs a beam sense signal. A main scanning synchronizing signal is generated on the basis of the beam sense signal and used to control record start timing in the main scanning direction and the generation of control signals for the input and output of image signals, which will be described later specifically.

The operation of the illustrative embodiment, mainly the IPU 502, up to the generation of image data to be input to the writing unit 157 from image data output from the scanning unit 150 will be described more specifically hereinafter.

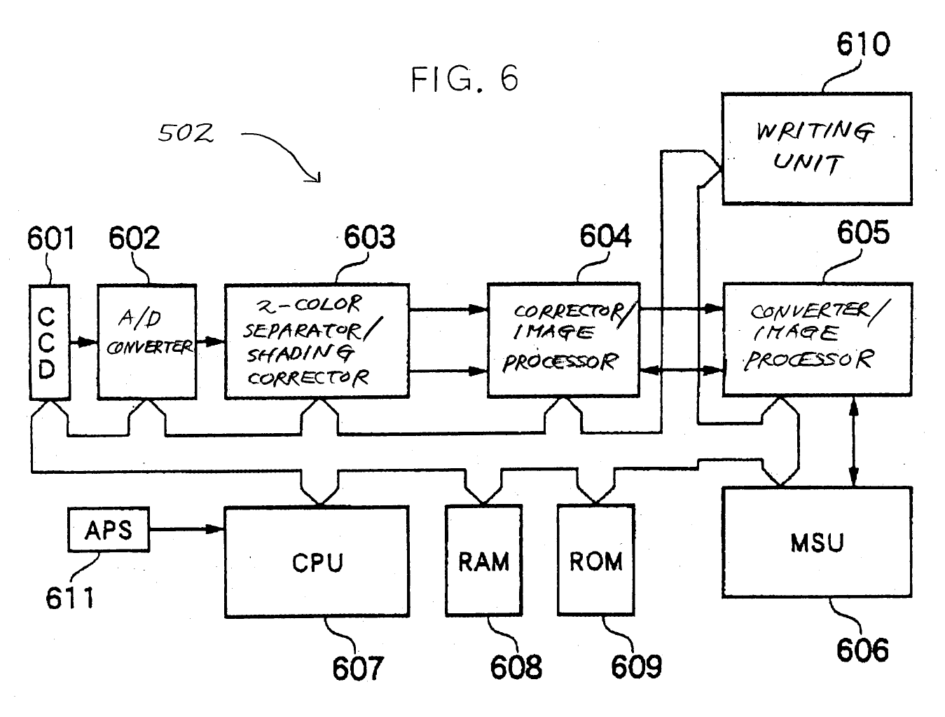

FIG. 6 shows circuitry arranged in the IPU 502, FIG. 5. While light, issuing from the lamp 151, illuminates a document surface, the resulting reflection from the document is incident to the CCD image sensor 154 via a lens not shown. As shown in FIG. 6, the circuitry includes a CCD image sensor 601 (corresponding to the CCD image sensor 154) for photoelectrically converting incident light to an analog image signal. An A/D (Analog-to-Digital) converter 602 converts the analog image signal to a corresponding digital image signal. The digital image signal is then routed through a two-color separator/shading corrector 603 to a corrector/image processor 604, which executes filter correction, magnification change, color data expansion and gamma correction as well as other conventional processing.

A converter/image processor 605 switches the destination of the digital image signal to either one of an image memory controller (MSU) 606 and a writing unit 610 (corresponding to the writing unit 157, FIG. 1). The MSU 606 and converter/image processor 605 are capable of interchanging the image signal.

The IPU 502 is capable of processing not only the image data input from the scanning unit 150 but also image data received from the outside, e.g., a personal computer or similar data processing terminal, although not shown specifically in FIG. 6.

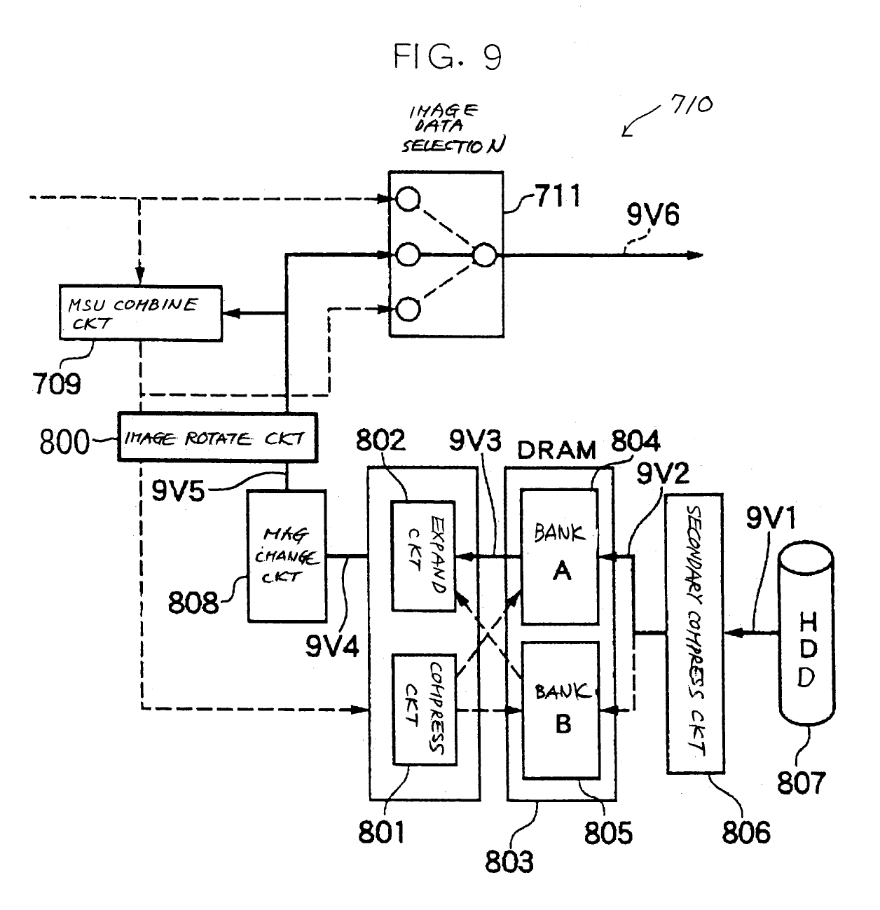

As shown in FIG. 6, the IPU 502 further includes a CPU (Central Processing Unit) 607 for setting, e.g., the MSU 606 and controlling the scanning unit 150 and writing unit 610, a ROM (Read Only Memory) 609 and a RAM (Random Access Memory) 608 for storing a program and data to be dealt with by the CPU 607. In addition, the CPU 607 is capable of writing or reading data in or out of an image memory 803, which will be described later with reference to FIG. 9, via the MSU 606.

FIG. 7 shows the converter/image processor 605 in detail. As shown, the image data output from the corrector/image processor 604 are input to a color converting circuit 702 via a scanner mask 701 and converted in color in accordance with the mode thereby. The image data output from the color converting circuit 702 is routed through a color deleting circuit 703, a bit or image inverting circuit 704 to a print combining circuit 705 and then unconditionally written to an MSU 710 (corresponding to the MSU 606, FIG. 6). The print combining circuit 705 composes, e.g., special characters to be printed. A print core 706 prepares the pages of page printing or prepares printing by using, e.g., stamp characters or a character code and then generates print image data. A ROM 707 and a RAM 708 store data to be used by the print core 706.

An image data selecting circuit 711 selectively delivers the image data sequentially processed by the circuits 701 through 705 through to an image quality core 12, delivers image data received from the MSU 710 to the image quality core 712 or delivers image data, which are produced by combining the image data processed by the circuits 701 through 705 and an image output from the MSU 710, to the image quality core 12.

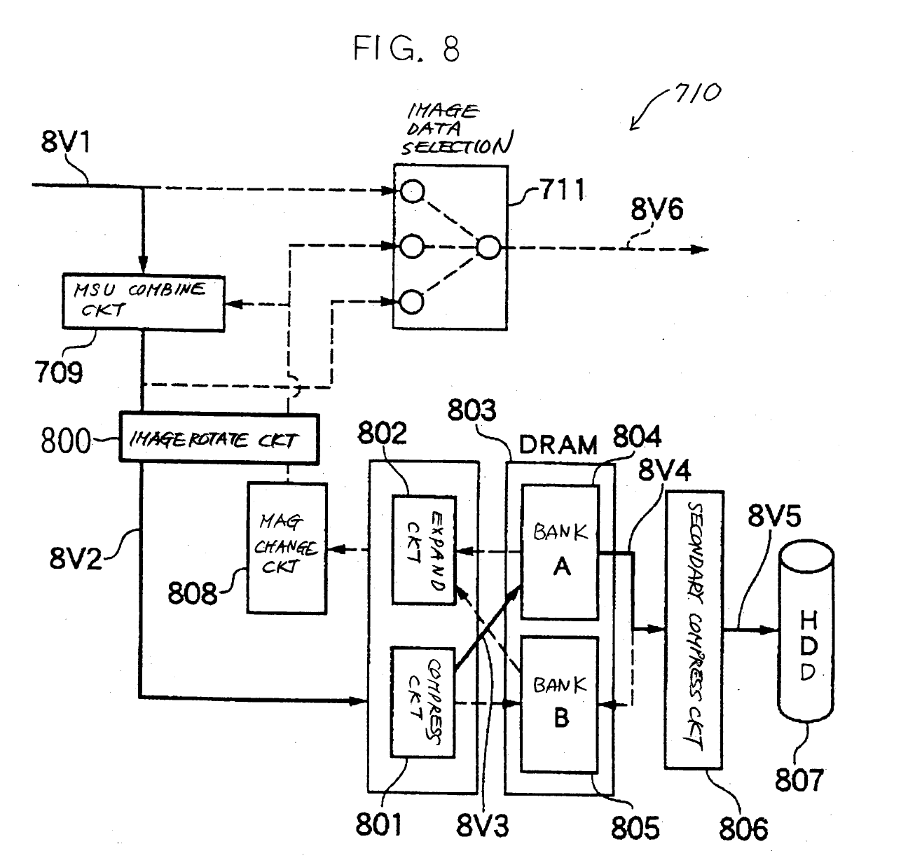

FIGS. 8 and 9 show the configuration and operation of the MSU 710 in detail. As shown, the MSU 710 includes a primary compressing circuit 801, a primary expanding circuit 802, a DRAM (Dynamic RAM) made up of banks A 804 and B 805 for storing primary image data, a secondary compressing/expanding circuit 806, a large-capacity HDD (Hard Disk Drive) 807, a magnification changing circuit 808 for changing the magnification of an expanded, registered image, and an image rotating circuit 800 for rotating the image subjected to MSU composition or magnification change. Control data are set in the above blocks by the CPU 607, FIG. 6.

As shown in FIGS. 8 and 9, the primary storage of the MSU 710 is implemented by the DRAM 803 or similar high-speed access memory and allows data to be written to or read out of a designated location in substantially synchronism with a data transfer rate required at the time of input/output of image data. Further, the RAM or primary storage 803 is divided into a plurality of areas (banks A 804 and B 805 in the illustrative embodiment) in accordance with the size of image data to be processed, so that image data can be input and output at the same time. In this sense, the RAM 803 serves as an interface to the MSU 710.

The HDD 807 or similar large-capacity memory constitutes the secondary storage of he MSU 710 and stores data for combining or sorting input images. The HDD 807, like the DRAM 803, allows data to be written in or read out in substantially synchronism with the data transfer rate required at the time of input/output of image data.

A specific operation of the MSU or memory controller 710 for writing image data in the HDD 807 will be described with reference to FIG. 8. As shown, the image data, labeled 8V1, output from the converter/image processor 605, FIGS. 6 and 7, are unconditionally input to an MSU combining circuit 709 and combined, if data to be combined are present in the image memory, with such data. When a rotation command is input at the time of document reading, the rotating circuit 800 rotates the image data output from the MSU combining circuit 709 by 90°, 180° or 270°. Subsequently, to store the so rotated image data, labeled 8V2, the primary compressing circuit 801 compresses the image data 8V2 and writes the compressed image data in the DRAM 803. Thereafter, the secondary compressing/expanding circuit 806 further compresses the image data and writes the so compressed image data in the HDD 807.

FIG. 9 demonstrates a specific operation of the MSU 710 for reading image data out of the HDD 807, storing the image data in the image memory, and then expanding and changing the magnification of the image data. As shown, image data stored in the DRAM or primary storage 803 are read out to produce an image. More specifically, if an image to be output is stored in the DRAM 803, then the image data read out of the DRAM 803 are expanded by the primary expanding circuit 802 and then directly output or output after being combined with input image data. At this instant, the magnification changing circuit 808 is capable of changing the magnification of the image thus expanded. If a rotation command is input at the time of laser writing, then rotating circuit 800 rotates the image data changed in magnification by any one of 90°, 180° and 270°. Subsequently, the MSU combining circuit 709 combines the rotated image data, labeled 9V5, and input data 8V1, FIG. 8, while adjusting the phase of the image data. The resulting combined image data are delivered to a designated destination, i.e., output as an image and/or written back to the DRAM 803.

If an image to be output is not stored in the DRAM 803, then image data, which are stored in the HDD 807 and the subject of output, are expanded by the secondary compressing/expanding circuit 806 and then written to the DRAM 803. This is followed by the image outputting procedure described above.

In the print mode stated earlier, the user can register desired images for stamping, as needed. More specifically, when a stamp image register mode is selected, images from the scanner are registered at the HDD 807. When the user selects desired one of the stamp images later, image data representative of the desired stamp image are read out of the HDD 807 and then fed to the MSU combining circuit 709 to be combined with a document image.

When a single image should be produced from a single document image, it is not necessary to store image data representative of the document image in the image memory. However, the illustrative embodiment unconditionally stores an image scanned and read in the DRAM or image memory 803 and HDD 807. This is advantageous in that when a plurality of images should be produced from a single document image, it is not necessary to repeatedly scan the same document and in that when a jam, for example, occurs, it is not necessary to again read the same document.

The duplex document combining function unique to the illustrative embodiment and effected in response to a command input on the duplex document composite key 310, FIG. 3, will be described hereinafter. To implement this function, the duplex document read mode stated earlier is executed to read both sides of a duplex document, and then the MSU combining processing stated above is executed by using image data derived from both sides of the document. To combine the image data, an image read from the first side of the document are written to the image memory and then combined with an image read from the second side of the same document by the MSU combining circuit 709 when the latter image are input. Alternatively, images read from both sides of the document may be written to the image memory and then combined by the MSU combining circuit 709 at the time of output. If desired, such two different schemes may even be used in combination.

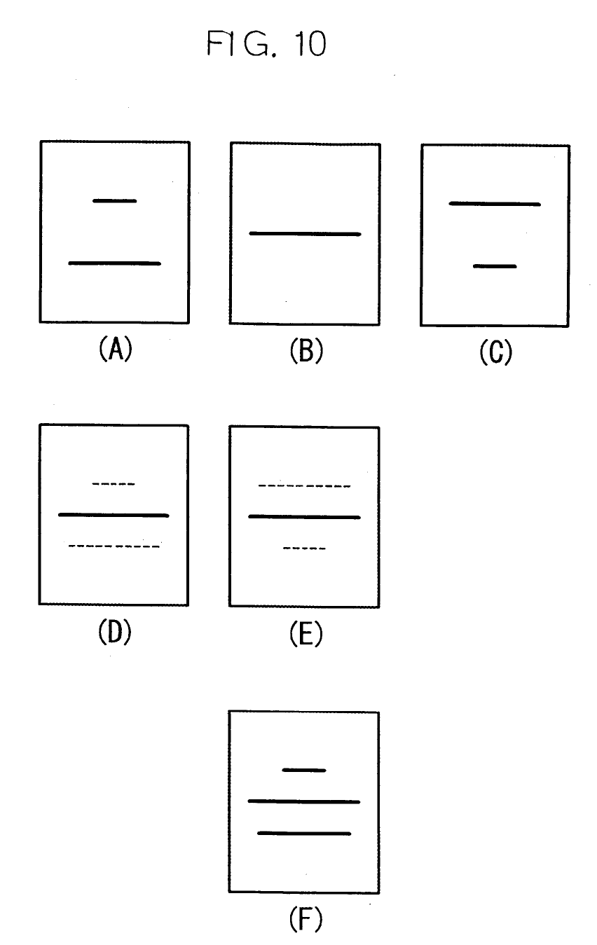

The duplex document combining function will be described more specifically hereinafter. First, a duplex document to be dealt with by the illustrative embodiment and a composite image thereof will be described. FIG. 10 shows a specific duplex document in different conditions (A) through (E) and a composite, copied image (F). Typically, a duplex document is either one of a document spread in the right-and-left direction and carrying images printed in the same direction on opposite sides thereof and a document spread in the up-and-down direction and carrying, on its reverse side, an image rotated by 180° relative to an image on the front side. While the two kinds of printing shown in FIG. 10 apply to duplex documents in general, even a copy produced by the duplex copying function of a conventional copier belongs to either one of them.

More specifically, in FIG. 10, assume that the front side and reverse side of a duplex document spread in the right-and-left direction carry images shown in (B) and (A), respectively. Then, when the same images are spread in the up-and-down direction, the reverse side is drawn as shown in (C). Stated another way, the reverse side of a duplex document spread in the right-and-left direction appears as indicated by dotted lines in (D) when looked through the document from the front side. On the other hand, the reverse side of a duplex document spread in the up-and-down direction appears as indicated by dotted lines in (E) when looked through the document.

Images must be combined in the correct direction as in (F), FIG. 10, without regard to the kind of drawing described above. However, the images on both sides of a duplex document and input to be combined have been read without giving consideration to the difference between right-and-left spread and up-and-down spread, i.e., by identical operation. It is therefore necessary to execute rotation with either one of images read from opposite sides of a duplex document.

In the illustrative embodiment, when the operator selects desired conditions, an image read by the duplex document read mode can be rotated in accordance with the conditions selected and adequately combined with the other image, as will be described hereinafter.

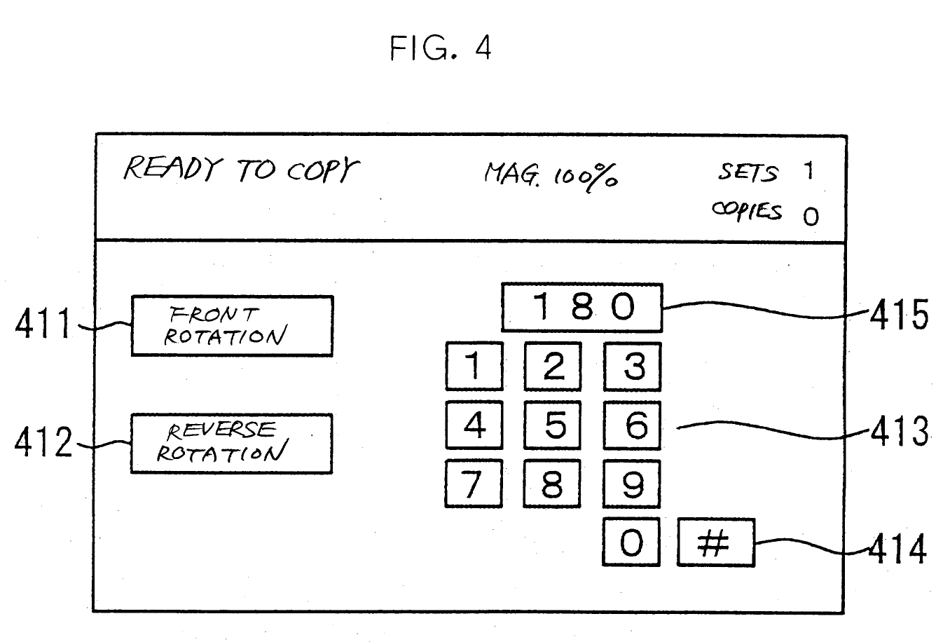

FIG. 4 shows a picture to appear on the LCD touch panel 201 for allowing the operator to select image combining conditions. More specifically, when the operator, stacked duplex documents on the tray 120 of the ADF 101, touches the duplex document composite key 310 appearing in the initial picture of FIG. 3, the picture of FIG. 4 appears on the touch panel 201. As shown in FIG. 4, the picture includes a front rotation key 411, a reverse rotation key 412, ten keys 413, a window 415 for indicating an angle of rotation selected on the ten keys 413, and an enter key 414 for setting the conditions selected.

When the operator desires to rotate an image on the front side of a duplex document, the operator touches the front rotation key 411, inputs, while watching the window 415, a necessary angle of rotation on the ten keys 413, and then sets such conditions on the enter key 414. As a result, the image on the front side is rotated and then combined with the image on the reverse side. Likewise, to rotate the image on the reverse side of the duplex document, the operator touches the reverse rotation key 412, inputs, while watching the window 415, a necessary angle of rotation on the ten keys 413, and then sets such conditions on the enter key 414. As a result, the image on the reverse side is rotated and then combined with the image on the front side.

The above procedure will be described more specifically by taking the duplex document spread in the right-and-left direction ((A) and (B), FIG. 10) and the duplex document spread in the up-and-down direction ((B) and (C), FIG. 10) as an example. Conditions to be set depend on the position of the document set on the tray 120, i.e., a landscape position or a profile position without regard to the direction of spread.

When the document spread in the right-and-left direction ((A) and (B), FIG. 10) is set on the tray 120 in a landscape position, it is not necessary to rotate any image. Therefore, only if the operator inputs a rotation angle of 0°, then images on both sides of the document can be combined without any rotation, producing the composite image ((F), FIG. 10). When the above document is set on the tray 120 in a profile position, if the operator selects a rotation angle of 180°, then the images on both sides of the document can be combined while being rotated by 180° relative to each other, also producing the composite image (F).

On the other hand, when the document spread in the up-and-down direction ((B) and (C), FIG. 10) is set on the tray 120 in a landscape position, if the operator selects a rotation angle of 180°, then the images on both sides of the document can be combined while being rotated by 180° relative to each other, producing the composite image (F). When the above document is set on the tray 120 in a profile position, it is not necessary to rotate any image. Therefore, only if the operator inputs a rotation angle of 0°, then images on both sides of the document can be combined without any rotation, producing the composite image (F).

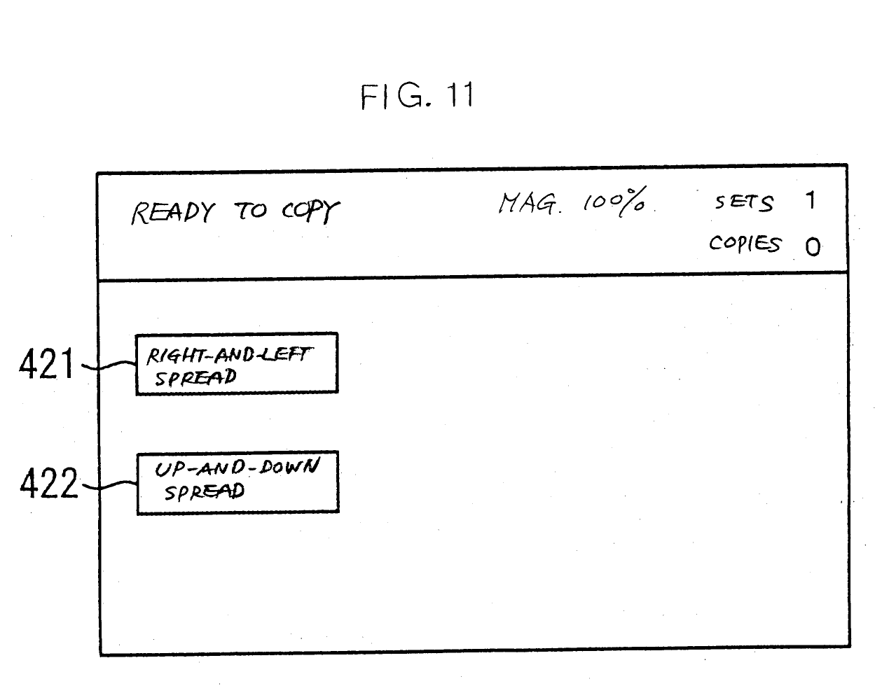

In an alternative procedure to be described hereinafter, the operator is expected to select either one of “right-and-left spread” and “up-and-down spread” as a condition for combining images on both sides of a duplex document. FIG. 11 shows a picture for allowing the operator to select a desired condition for combining images on both sides of a duplex copy. The picture of FIG. 11 appears when the operator, stacked duplex documents on the tray 120 of the ADF 101, touches the duplex document composite key 310 appearing in the initial picture of FIG. 3. As shown, the picture includes a right-and-left spread key 142 and an up-and-down spread key 422 assigned to a document spread in the right-and-left direction and a document spread in the up-and-down direction, respectively.

The operator touches the right-and-left spread key 421 when stacked duplex documents spread in the right-and-left direction on the tray 120 of the ADF 101 or touches the up-and-down spread key 422 when stacked duplex documents spread in the up-and-down direction. In response, the processing for combining images on both sides of a duplex document is executed. In this case, as for a document spread in the right-and-left direction, images on both sides thereof can be combined without any image rotation. As for a document spread in the up-and-down direction, an image on the reverse side is rotated by 180° relative to an image on the front side and then combined to produce the composite image (F), FIG. 10.

This specific procedure, however, must distinguish the landscape position and profile position of the documents set on the tray 120. More specifically, when a duplex document spread in the right-and-left direction ((A) and (B), FIG. 10) is set in a landscape position, the operator simply touches the right-and-left spread key 421, so that opposite sides of the document are combined without any image rotation. When such a document is set in a profile position, the operator touches the up-and-down spread key 422 because it is reasonable to regard the document as one spread in the up-and-down direction. In this case, the image on the reverse side is rotated by 180° and then combined with the image on the front side to produce the composite image (F), FIG. 10.

On the other hand, when a duplex document spread in the up-and-down direction ((B) and (C), FIG. 10) is set in a landscape position, the operator simply touches the up-and-down spread key 422, so that the image on the reverse side is rotated by 180° and then combined with the image on the front side. When such a document is set in a profile position, the operator touches the right-and-left spread key 421 because it is reasonable to regard the document as one spread in the right-and-left direction. In this case, the images on both sides of the document are combined without any image rotation to produce the composite image (F), FIG. 10.

As stated above, the specific procedure described above allows images on both sides of a duplex document to be easily combined only if the operator selects either one of “right-and-left spread” and “up-and-down spread”.

In summary, it will be seen that the present invention provides an image forming apparatus achieving various unprecedented advantages, as enumerated below.

(1) The apparatus includes means for reading images carried on both sides of a duplex document one by one and means for combining resulting image data. The apparatus therefore omits load on the operator heretofore required to convert the duplex document to simplex documents and then inputs conditions for combining the simplex documents.

(2) Images on both sides of a duplex document are rotated relative to each other and then combined, so that adequate processing for outputting a desired composite image can be executed.

(3) Means is provided for allowing the operator to select one of the opposite images to be rotated, implementing more adequate condition setting.

(4) Means for allowing the operator to vary an angle by which an image should be rotated is provided, promoting optimum condition setting in accordance with the conditions of images carried on both sides of a duplex document.

(5) The operator is capable of setting either one of a duplex document spread in the right-and-left direction and a duplex document spread in the up-and-down direction and selecting, when set the former spread position, zero rotation angle. The operator selects, when set the latter spread position, a rotation angle of 180°. Therefore, only if the operator sets either one of the two different spread positions, images on both sides of a duplex document can be adequately combined in both of the two spread positions.

Various modifications will become possible for those skilled in the art after receiving the teachings of the present disclosure without departing from the scope thereof.

What is claimed is:

1. An image forming apparatus capable of combining image data representative of images carried on both sides of a duplex document, said image forming apparatus comprising:
reading means for reading the images on both sides of the duplex document;
storing means for storing image data derived from the images of both sides of the duplex document;
combining means for combining the image data stored to thereby output combined image data; and
image forming means for forming a composite image in accordance with the combined image data.

2. The apparatus as claimed in claim 1, wherein said combining means combines the images of both sides of the duplex document by rotating said images relative to each other.

3. The apparatus as claimed in claim 2, further comprising side setting means for selecting either one of the images of both sides of the duplex document to be rotated.

4. The apparatus as claimed in claim 3, further comprising inputting means for allowing an operator of said apparatus to set the image to be rotated.

5. The apparatus as claimed in claim 3, further comprising angle setting means for variably setting an angle of rotation of the image.

6. The apparatus as claimed in claim 5, further comprising spread setting means for setting whether the duplex document is spread in a right-and-left direction or in an up-and-down direction, wherein when the right-and-left direction is set, the angle of rotation is selected to be 0°.

7. The apparatus as claimed in claim 6, wherein when the up-and-down direction is set, the angle of rotation is selected to be 180°.

8. The apparatus as claimed in claim 7, further comprising inputting means for allowing an operator of said apparatus to set the image to be rotated.

9. The apparatus as claimed in claim 2, further comprising angle setting means for variably setting an angle of rotation of the image.

10. The apparatus as claimed in claim 9, further comprising spread setting means for setting whether the duplex document is spread in a right-and-left direction or in an up-and-down direction, wherein when the right-and-left direction is set, the angle of rotation is selected to be 0°.

11. The apparatus as claimed in claim 10, wherein when the up-and-down direction is set, the angle of rotation is selected to be 180°.

12. The apparatus as claimed in claim 11, further comprising inputting means for allowing an operator of said apparatus to set the image to be rotated.

13. The apparatus as claimed in claim 9, wherein when the up-and-down direction is set, the angle of rotation is selected to be 180°.

14. The apparatus as claimed in claim 9, further comprising inputting means for allowing an operator of said apparatus to set the image to be rotated.

15. An image forming apparatus capable of combining image data representative of images carried on both sides of a duplex document, said image forming apparatus comprising:
a reading device for reading the images on both sides of the duplex document;
a storing device for storing image data derived from the images of both sides of the duplex document;
a combining device for combining the image data stored to thereby output combined image data; and
an image forming device for forming a composite image in accordance with the combined image data.

16. The apparatus as claimed in claim 15, wherein said combining device combines the images of both sides of the duplex document by rotating said images relative to each other.

17. The apparatus as claimed in claim 16, further comprising a side setting device for selecting either one of the images of both sides of the duplex document to be rotated.

18. The apparatus as claimed in claim 17, further comprising an inputting device for allowing an operator of said apparatus to set the image to be rotated.

19. The apparatus as claimed in claim 17, further comprising an angle setting device for variably setting an angle of rotation of the image.

20. The apparatus as claimed in claim 19, further comprising a spread setting device for setting whether the duplex document is spread in a right-and-left direction or in an up-and-down direction, wherein when the right-and-left direction is set, the angle of rotation is selected to be 0°.

21. The apparatus as claimed in claim 20, wherein when the up-and-down direction is set, the angle of rotation is selected to be 180°.

22. The apparatus as claimed in claim 21, further comprising an inputting device for allowing an operator of said apparatus to set the image to be rotated.

23. The apparatus as claimed in claim 16, further comprising an angle setting device for variably setting an angle of rotation of the image.

24. The apparatus as claimed in claim 23, further comprising a spread setting device for setting whether the duplex document is spread in a right-and-left direction or in an up-and-down direction, wherein when the right-and-left direction is set, the angle of rotation is selected to be 0°.

25. The apparatus as claimed in claim 24, wherein when the up-and-down direction is set, the angle of rotation is selected to be 180°.

26. The apparatus as claimed in claim 25, further comprising an inputting device for allowing an operator of said apparatus to set the image to be rotated.

27. The apparatus as claimed in claim 23, wherein when the up-and-down direction is set, the angle of rotation is selected to be 180°.

28. The apparatus as claimed in claim 23, further comprising an inputting device for allowing an operator of said apparatus to set the image to be rotated.

29. An image forming method for combining image data representative of images carried on both sides of a duplex document, said image forming method comprising the steps of:
(a) reading the images on both sides of the duplex document;
(b) storing image data derived from the images of both sides of the duplex document;
(c) combining the image data stored to thereby output combined image data; and
(d) forming a composite image in accordance with the combined image data.

30. The method as claimed in claim 29, wherein step (c) comprises rotating the images relative to each other.

31. The method as claimed in claim 30, wherein step (c) comprises selecting either one of the images of both sides of the duplex document to be rotated.

32. The method as claimed in claim 31, wherein step (c) comprises causing an operator to set the image to be rotated.

33. The method as claimed in claim 31, wherein step (c) comprises variably setting an angle of rotation of the image.

34. The method as claimed in claim 33, further comprising (e) setting whether the duplex document is spread in a right-and-left direction or in an up-and-down direction, wherein when the right-and-left direction is set, the angle of rotation is selected to be 0°.

35. The method as claimed in claim 34, wherein when the up-and-down direction is set, the angle of rotation is selected to be 180°.

36. The method as claimed in claim 35, wherein step (c) comprises causing an operator to set the image to be rotated.
